(19) United States
(12) Patent Application Publication
(10) Pub. No.: US 2026/0120496 A1
(43) Pub. Date: Apr. 30, 2026

(54) DRAWING PROCESSING DEVICE AND DRAWING PROCESSING METHOD

(71) Applicant: REVOX Corporation, Shizuoka-shi, Shizuoka (JP)

(72) Inventors: Cam Hao Phung, Yaizu-shi, Shizuoka (JP); Hiroshi Shikanai, Yaizu-shi, Shizuoka (JP)

(73) Assignee: REVOX Corporation, Shizuoka-shi, Shizuoka (JP)

(21) Appl. No.: 19/116,832

(22) PCT Filed: Aug. 26, 2024
(86) PCT No.: PCT/JP2024/030203

§ 371 Date: Mar. 28, 2025

(30) Foreign Application Priority Data
Apr. 3, 2024 (JP) 2024-059907

(51) Int. Cl. G06V 30/412; G06V 10/70; G06V 30/10; G06V 30/422

(52) U.S. Cl. CPC G06V 30/412; G06V 10/70; G06V 30/10; G06V 30/422

(57) ABSTRACT

Problem: To provide a drawing processing device capable of acquiring information in a table included in drawing data.

Solution to Problem: A drawing processing device includes a drawing reception unit (202) configured to receive drawing data (D10) including characters in boxes divided by rule lines and including one or more tables in which attributes of the characters are defined in the boxes, and a drawing processing unit (204A) configured to acquire table information related to a table to be detected in a drawing area (10) of the drawing data (D10) received by the drawing reception unit (202) from a candidate area (14) containing the table to be detected, the table including a feature to be detected.

### TECHNICAL FIELD

The present invention relates to a drawing processing device and a drawing processing method.

### BACKGROUND OF INVENTION

Drawings used in various industries, such as machinery, construction, civil engineering, electricity, and apparel contain various pieces of information written in characters in addition to lines (outlines, dimensions, etc.) that indicate shape and structure. Since the characters contained in drawings are important information for understanding the content of the drawings, systems have been developed to make use of this information. For example, Patent Document 1 discloses a support system that acquires characters representing dimension values written alongside dimension lines in a drawing and creates a list of the dimension values of the drawing.

### PRIOR ART

### Patent Literature

Patent Document 1: JP H10-293777 A

### SUMMARY OF INVENTION

### Problem to be Solved by Invention

As described above, in addition to characters representing dimension values, drawings include various information in table form. In the information in table form, each box separated by a rule line has a defined attribute, and characters corresponding to each attribute are written in each box. However, in the support system disclosed in Patent Document 1, the only characters to be acquired from a drawing are characters that represent the dimensions written alongside the dimension lines in the drawing. Since the characters written in table format are ignored, the system cannot properly acquire important information needed to understand the content of the drawing.

The present invention was made in view of the above problem, and an object of the present invention is to provide a drawing processing device and a drawing processing method capable of acquiring information in a table included in drawing data.

### Means for Solving the Problem

In order to achieve the object described above, a drawing processing device according to an aspect of the present invention includes:
a drawing reception unit configured to receive drawing data including characters in boxes divided by rule lines and including one or more tables in which attributes of the characters are defined in the boxes; and
a drawing processing unit configured to acquire table information related to a table to be detected in a drawing area of the drawing data received by the drawing reception unit from a candidate area containing the table to be detected, the table including a feature to be detected.

### Effect of the Invention

With the drawing processing device according to an aspect of the present invention, it is possible to acquire information in a table included in drawing data.

Problems, configurations, and effects other than those described above will become clear in the following description of the embodiments for implementing the present invention.

### BRIEF DESCRIPTION OF THE DRAWINGS

FIG. 1 is an overall configuration diagram showing an example of a drawing management system 1.

FIG. 2 is a diagram showing an example of drawing data D10.

FIG. 3 is a diagram showing an example of a drawing database 210.

FIG. 4 is a block diagram showing an example of a drawing processing device 2A according to a first embodiment.

FIG. 5 is a functional illustration of an example of a learning model generation unit 201A according to the first embodiment.

FIG. 6 is a functional illustration of an example of a drawing reception unit 202, a character recognition unit 203, and a drawing processing unit 204A according to the first embodiment.

FIG. 7 is a hardware configuration diagram showing an example of a computer 900.

FIG. 8 is a flowchart showing an example of the operation (drawing processing method) of the drawing processing device 2A according to the first embodiment.

FIG. 9 is a block diagram showing an example of a drawing processing device 2B according to a second embodiment.

FIG. 10 is a functional illustration of an example of a learning model generation unit 201B according to the second embodiment.

FIG. 11 is a functional illustration of an example of a drawing reception unit 202, a character recognition unit 203, and a drawing processing unit 204B according to the second embodiment.

FIG. 12 is a flowchart showing an example of the operation (drawing processing method) of the drawing processing device 2B according to the second embodiment.

### EMBODIMENTS FOR IMPLEMENTING THE INVENTION

The following is a description of embodiments for implementing the present invention with reference to the drawings. In the following description, the scope necessary for explanation to achieve the object of the present invention will be described schematically, explanation will focus on the scope necessary for the explanation of relevant parts of the present invention, and any parts that are omitted shall be based on the known art.

### First Embodiment

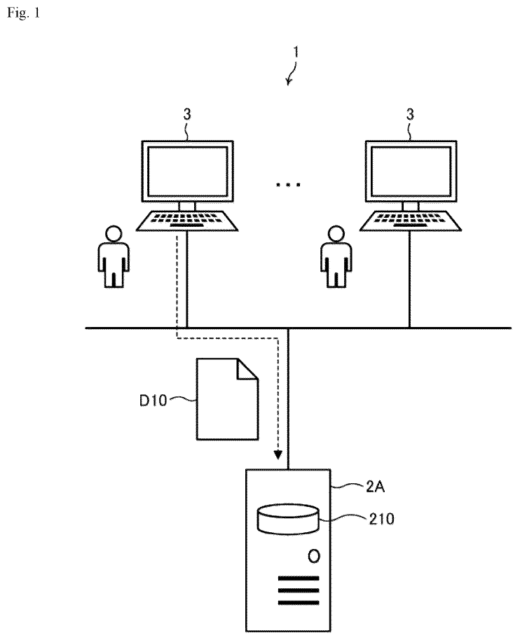

FIG. 1 is an overall configuration diagram showing an example of a drawing management system 1. The drawing management system 1 functions as a system that manages drawing data D10.

The drawing data D10 handled by the drawing management system 1 is, for example, any type of drawing recorded as digital data, such as assembly drawings and parts drawings for mechanical drawings, architectural drawings, electrical circuit diagrams, pneumatic circuit diagrams, hydraulic circuit diagrams, and apparel drawings. In this case, the drawing data D10 can be either vector-format data or raster-format data. For example, the drawing data D10 can be CAD data (an example of the vector-format data) output by any type of CAD software, or image data (an example of the raster-format data) output by scanning a drawing printed on paper media. Furthermore, the drawing data D10 can be created using any projection method and can be three-dimensional. In addition, the drawing data D10 can be any type of data that includes a table, and may be a document such as a form recorded as digital data.

As shown in FIG. 1, the drawing management system 1 includes a drawing processing device 2A and a user terminal device 3. The drawing processing device 2A and the user terminal device 3 are connected to a wired or wireless network 4 and are configured to mutually send and receive various types of data. The number of drawing processing devices 2A and user terminal devices 3 and the connection configuration of these devices with the network 4 are not limited to the example shown in FIG. 1 and may be changed as required.

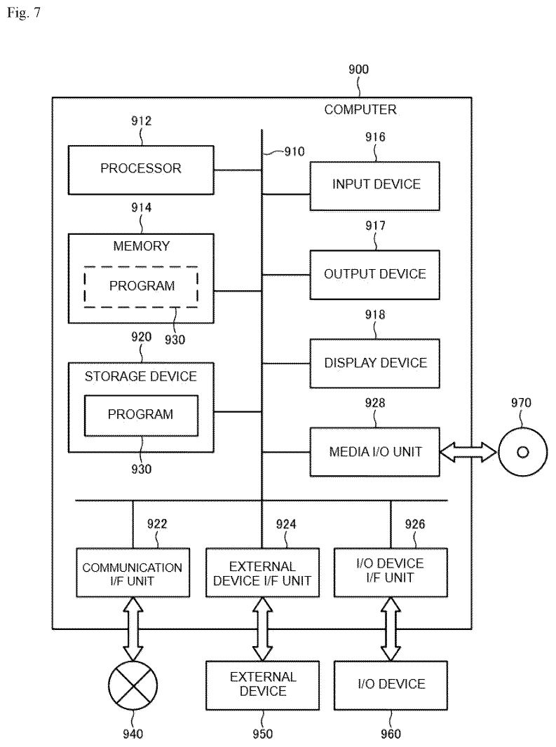

The drawing processing device 2A is a server-type computer or a cloud-type computer, and is composed of a general-purpose computer or a dedicated computer (see FIG. 7 described below), for example. The drawing processing device 2A includes a drawing database 210 that can register the drawing data D10 and incidental information (details will be provided below) included in the drawing data D10 in association with each other.

The drawing processing device 2A accepts new drawing data D10 from the user terminal device 3, acquires the incidental information included in the drawing data D10, and registers the drawing data D10 and the incidental information in the drawing database 210. Further, the drawing processing device 2A references the (existing) drawing data D10 and incidental information registered in the drawing database 210 and provides display information for editing or the like to the user terminal device 3.

The user terminal device 3 is a client-type computer and is composed of a general-purpose computer or a dedicated computer (see FIG. 7 described below), for example. The user terminal device 3 accepts various input operations via a display screen, such as an application or a browser, such that a user can register new drawing data D10, reference existing drawing data D10, or edit the drawing data D10, and outputs various information via the display screen or sound.

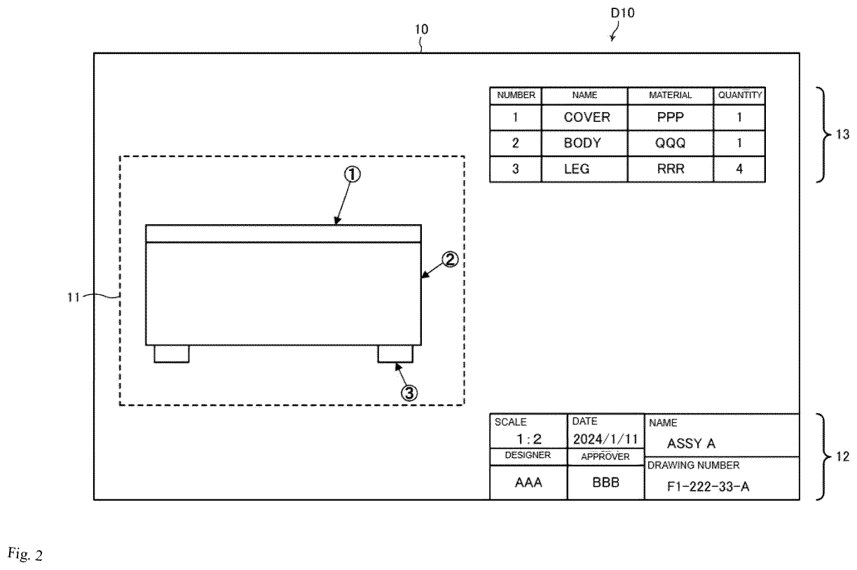

FIG. 2 is a diagram showing an example of the drawing data D10. This embodiment will focus on a case where, as shown in FIG. 2, the drawing data D10 is an assembly diagram.

A shape area 11, a title field 12, and a parts table 13 are arranged in a drawing area 10 of the drawing data D10. The drawing area 10 corresponds to the entire area of the paper when the drawing data D10 is printed on paper medium.

The shape area 11 is an area in which the shape or structure of assemblies or parts are described. Examples of lines that define the shape and structure of assemblies or parts in the shape area 11 are outline lines, dimension lines, hidden lines, center lines, and imaginary lines. The shape area 11 also includes characters that indicate dimensions, tolerances, part numbers, and the like.

The title field 12 and the parts table 13 are types of tables in the drawing data D10. Each table has both vertical and horizontal lines and boxes separated by the lines. Each box contains characters, and each box has an attribute that defines the characters contained within it. The boxes are also classified by properties that indicate the type of box. The properties include the attribute heading property, serial number heading property, field property without attributes, and field property with attributes.

As shown in FIG. 2, examples of the attribute of the title field 12 include part name, drawing number, scale, date, designer, and approver. The boxes in the title field 12 are classified into three categories: attribute-present field property, attribute-heading property, and attribute-absent field property. The box classified as attribute-present field property contains field characters (in the example in FIG. 2, “1:2”, “2024/1/11”, “ASSY A”, “F1-222-33-A”) and attribute characters that define the attributes of the field characters (in the example in FIG. 2, “Scale”, “Date”, “Part name”, and “Drawing number”). The box classified as attribute-heading property contains attribute characters that determine the attributes of the field characters (in the example in FIG. 2, “Designer” and “Approver”). The box classified as attribute-absent field property contains field characters representing the contents of the title field 12 (in the example in FIG. 2, “AAA” and “BBB”).

As shown in FIG. 2, examples of the attributes of the parts table 13 include number, name, material, and quantity. The box in the first row on the top of the parts table 13 is classified as an attribute-heading property and contains attribute heading characters (in the example in FIG. 2, “Number”, “Name”, “Material”, and “Quantity”) as headings of the attributes of each column in the parts table 13. The box in the first column on the left of the parts table 13 is classified as a sequential number heading property and contains sequential number heading characters (in the example in FIG. 2, “1”, “2”, and “3”) that define the sequential number for each line of the parts table 13 as a heading. The other boxes in the parts table 13 are classified as attribute-absent field properties with no attribute characters and contain field characters (in the example in FIG. 2, “COVER”, “PPP”, “1”, “BODY”, “QQQ”, “1”, “LEG”, “RRR”, and “4”) as the contents of the parts table 13.

The types of tables included in the drawing data D10 are not limited to the title field 12 and the parts table 13 and may be other types of tables. In addition, the arrangement and quantity of the boxes that make up the table may be changed as appropriate according to the type of table, and the attributes defined for each box are not limited to the above examples.

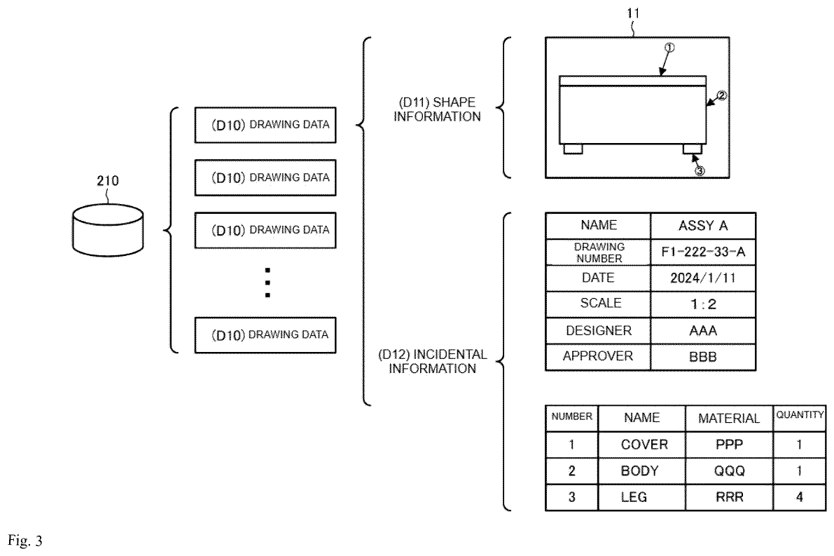

FIG. 3 is a diagram showing an example of the drawing database 210. For each drawing data D10 in image data format, shape information D11 contained in the drawing data D10 and incidental information D12 contained in the drawing data D10 are registered in association with each other in the drawing database 210.

The shape information D11 is generated by extracting the shape area 11 contained in the drawing area 10 and registered in the drawing database 210.

The incidental information D12 is generated by acquiring characters in the drawing area 10 (mainly the field characters) as text data by attribute and registered in the drawing database 210. FIG. 3 shows a case where the text data by attribute acquired from the title field 12 and the parts table 13 included in the drawing data D10 shown in FIG. 2 is registered in the drawing database 210 as the incidental information D12.

In the drawing database 210, the incidental information D12 that is registered in association with the drawing data D10 is not limited to the contents of the title field 12 and the parts table 13 and any information can be associated as necessary. For example, the drawing database 210 may be configured to allow the registration of information based on the shape area 11 (dimensions, tolerances, surface treatment, heat treatment, etc.) and information related to estimate requests (user name, date and time of estimate, estimate price, etc.), but no limitation is intended.

### (Configuration of Drawing Processing Device 2A)

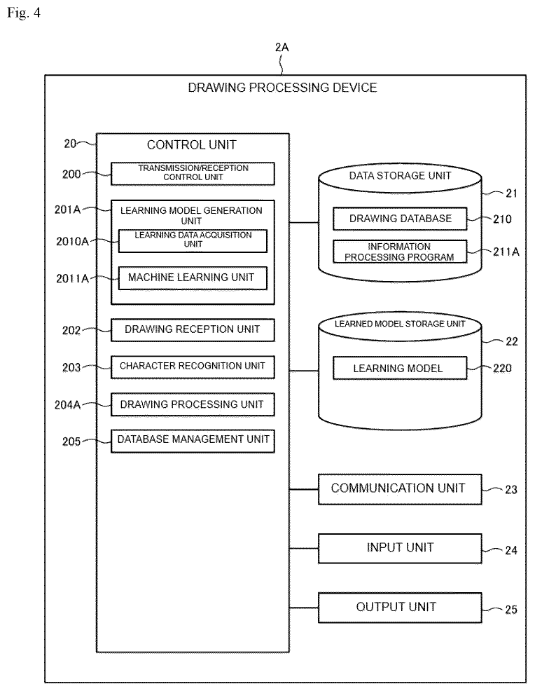

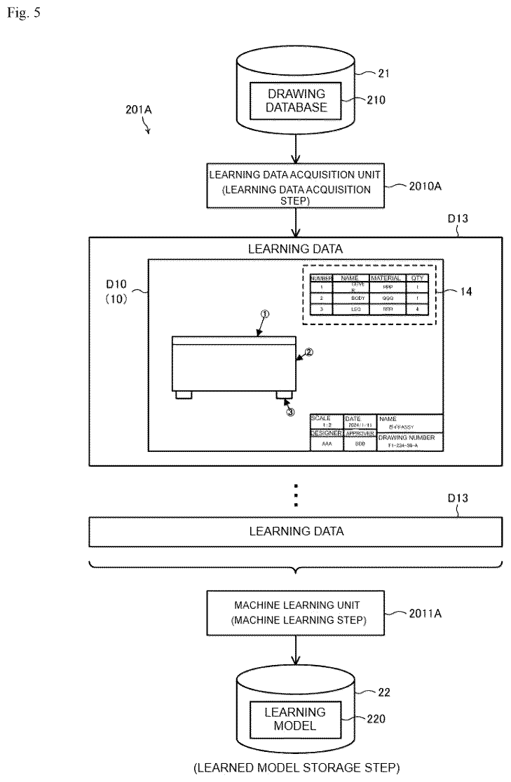

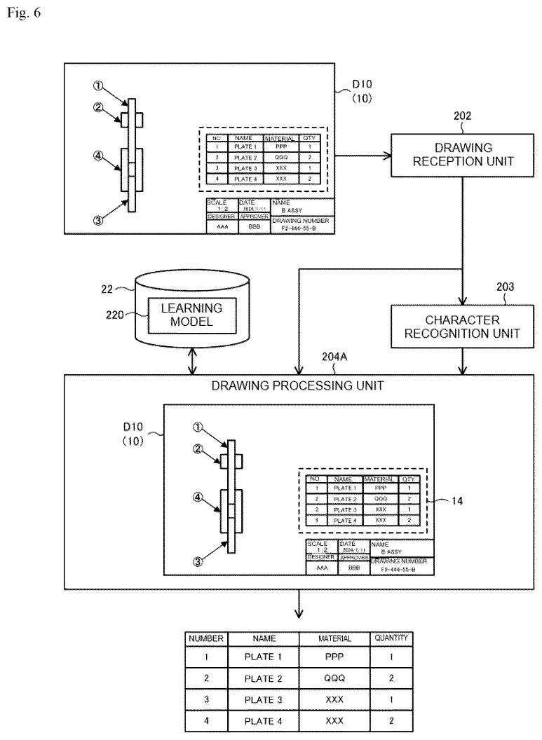

FIG. 4 is a block diagram showing an example of the drawing processing device 2A according to a first embodiment. FIG. 5 is a functional illustration of an example of a learning model generation unit 201A according to the first embodiment. FIG. 6 is a functional illustration of an example of a drawing reception unit 202, a character recognition unit 203, and a drawing processing unit 204A according to the first embodiment.

The drawing processing device 2A includes a control unit 20, a data storage unit 21, a learned model storage unit 22, a communication unit 23, an input unit 24, and an output unit 25.

The communication unit 23 is connected to an external device (e.g., the user terminal device 3) via the network 4 and functions as a communication interface for sending and receiving various types of data. The input unit 24 and the output unit 25 function as a user interface by accepting various input operations and outputting various information via a display screen or sound, respectively. Note that, the input unit 24 and the output unit 25 may be omitted.

The data storage unit 21 stores the drawing database 210 and an information processing program 211A. As shown in FIG. 3, a plurality of types of information included in the drawing data D10 are registered in the drawing database 210 in association with each other. The specific configuration of the drawing database 210 is not limited to the example of FIG. 3 and may be designed as required.

The learned model storage unit 22 stores a learned learning model 220. The learning model 220 stored in the learned model storage unit 22 may be provided to another device via the network 4, a recording media, or other means. The number of learning models 220 stored in the learned model storage unit 22 is not limited to one, and multiple inference models with different conditions, such as different machine learning methods or different data, may be stored and used selectively or in parallel with one another.

In FIG. 3, the data storage unit 21 and the learned model storage unit 22 are shown as two storage units, but the data storage unit 21 and the learned model storage unit 22 may comprise a single storage unit or three or more storage units. Further, at least one of the data storage unit 21 and the learned model storage unit 22 may comprise the storage unit of an external computer (e.g., a server-based computer or a cloud-based computer).

The control unit 20 executes the information processing program 211A recorded in the data storage unit 21 to function as a transmission/reception control unit 200, a learning model generation unit 201A, a drawing reception unit 202, a character recognition unit 203, a drawing processing unit 204A, and a database management unit 205.

### (Transmission/Reception Control Unit 200)

The transmission/reception control unit 200 transmits/receives various types of data to/from an external device (e.g., the user terminal device 3). For example, the transmission/reception control unit 200 transmits, to the user terminal device 3, display information for outputting various display screens to the user terminal device 3 and receives, from the user terminal device 3, operation information for receiving input operations performed on the display screen of the user terminal device 3. At this time, the transmission/reception control unit 200 coordinates with the units 201 to 205 to transmit the display information to the user terminal device 3 and receives the operation information from the user terminal device 3.

### (Learning Model Generation Unit 201A)

As shown in FIGS. 4 and 5, the learning model generation unit 201A includes a learning data acquisition unit 2010A and a machine learning unit 2011A.

The learning data acquisition unit 2010A references the drawing database 210 and acquires learning data D13 consisting of input data and output data. The learning data D13 is data used as teacher data (training data), validation data, and test data in supervised learning. The output data of the learning data D13 is the data used as the correct answer labels in supervised learning.

The input data of the learning data D13 is the drawing data D10. The input data of the learning data D13 may include text data representing characters in the drawing area 10 and position data indicating the position of the characters as a recognition result of the character recognition unit 203.

The output data of the learning data D13 is a candidate area 14 surrounding a table to be detected in the drawing area 10 of the drawing data D10. In the drawing data D10 shown in FIG. 2, the table to be detected corresponds to the title field 12 and the parts table 13. This embodiment will focus on a case where the table to be detected is the parts table 13.

The learning data acquisition unit 2010A acquires the learning data D13 by annotating the drawing data D10 that has already been registered in the drawing database 210. For example, the learning data acquisition unit 2010A acquires the learning data D13 by displaying the drawing data D10 on a display screen of the drawing processing device 2A or the user terminal device 3 and accepting input operations for candidate areas 14 that surround the table to be detected in the drawing area 10 on the display screen as annotations. Alternatively, the learning data acquisition unit 2010A may acquire the learning data D13 in cooperation with an external device connected via the network 4.

The machine learning unit 2011A performs machine learning to cause a learning model 220 to learn the correlation between the input data and the output data by using a plurality of sets of the learning data D13 acquired by the learning data acquisition unit 2010A. Examples of the learning model 220 include a model using a neural network (including deep learning) such as a convolutional neural network, a recurrent neural network, or a vision transformer, a tree type model such as a decision tree or a regression tree, ensemble learning such as bagging or boosting, clustering such as hierarchical clustering, non-hierarchical clustering, the k-nearest neighbor method, and the k-means method, multivariate analysis such as principal component analysis, factor analysis, and logistic regression, and a support vector machine.

In addition, the timing at which the machine learning unit 2011A causes the learning model generation unit 201A to perform machine learning may be when the number of drawing data D10 registered in the drawing database 210 exceeds a predetermined number or when a user instruction is received, but no limitation is intended.

### (Drawing Reception Unit 202)

The drawing reception unit 202 accepts new drawing data D10 by receiving the drawing data D10 from the user terminal device 3 via the transmission/reception control unit 200, for example.

### (Character Recognition Unit 203)

The character recognition unit 203 recognizes the characters included in the new drawing data D10 received by the drawing reception unit 202. The character recognition unit 203 recognizes the characters included in the drawing data D10 by, for example, performing optical character recognition (OCR) and reading the characters as text data. As a result of character recognition, text data indicating the relevant characters and position data indicating the position where the relevant characters are written are obtained. At this time, the character recognition result may be displayed on the display screen of the user terminal device 3, and editing operations may be performed by the user. If text data is embedded in the drawing data D10, the character recognition unit 203 may recognize the characters contained in the drawing data D10 by reading the text data.

### (Drawing Processing Unit 204A)

As shown in FIG. 6, the drawing processing unit 204A acquires table information related to the table to be detected from the candidate area 14, which is the area of the drawing area 10 of the new drawing data D10 received by the drawing reception unit 202 and where the table to be detected including a feature to be detected is located.

Specifically, the drawing processing unit 204A performs a candidate area identification process that identifies the candidate area 14 where the table to be detected is located in the drawing area 10 of the new drawing data D10, and a table information acquisition process that acquires the table information from the candidate area 14 identified by the candidate area identification process.

As the candidate area identification process, the drawing processing unit 204A identifies the candidate area 14 in the drawing area 10 of the new drawing data D10 by inputting the new drawing data D10 into the learning model 220. In addition to inputting the drawing data D10 into the learning model 220, if text data indicating the characters written in the drawing area 10 and position data indicating the position where the characters are written are also input, the drawing processing unit 204A need only input the recognition results of the character recognition unit 203 for the drawing data D10.

As the table information acquisition process, the drawing processing unit 204A acquires the table information on the basis of characters in a box disposed in the candidate area 14 of the characters recognized by the character recognition unit 203 and the attributes specified for the boxes. In this case, the drawing processing unit 204A acquires the table information by recognizing the composition of the table format on the basis of the arrangement and properties of each box, and acquires the characters in the boxes as characters for each attribute.

### (Database Management Unit 205)

The database management unit 205 registers the table information acquired as the processing result of the drawing processing unit 204A for the new drawing data D10 in the drawing database 210 as the incidental information D12 and in association with the drawing data D10. Further, the database management unit 205 sends display information to the user terminal device 3 via the transmission/reception control unit 200 in order to display the processing results of the drawing processing unit 204A.

The database management unit 205 reads the drawing data D10 that is registered in the drawing database 210 and transmits display information for displaying the registered drawing data D10 to the user terminal device 3 via the transmission/reception control unit 200. Further, the database management unit 205 modifies the drawing data D10 that is registered in the drawing database 210 when the database management unit 205 receives operation information for editing the drawing data D10 from the user terminal device 3 via the transmission/reception control unit 200.

### (Hardware Configuration of Each Device)

FIG. 7 is a hardware configuration diagram of the computer 900. The drawing processing device 2A and the user terminal device 3 in the drawing management system 1 are each configured by a general-purpose or dedicated computer 900.

As shown in FIG. 7, the computer 900 includes, as major components, a bus 910, a processor 912, a memory 914, an input device 916, an output device 917, a display device 918, a storage device 920, a communication interface (I/F) unit 922, an external device I/F unit 924, an input/output (I/O) device I/F unit 926, and a media I/O unit 928. Note that, the above components may be omitted as appropriate depending on the application in which the computer 900 is used.

The processor 912 is configured by one or more arithmetic processing units (central processing unit (CPU), micro-processing unit (MPU), digital signal processor (DSP), graphics processing unit (GPU), etc.) and operates as a control unit that controls the entire computer 900. The memory 914 stores various data and a program 930, and is configured by a volatile memory (DRAM, SRAM, etc.) that functions as the main memory and a non-volatile memory (ROM) or a flash memory.

The input device 916 is configured by, for example, a keyboard, a mouse, a numeric keypad, an electronic pen, or a microphone, and functions as an input unit. The output device 917 is configured by, for example, a sound (voice) output device or a vibration device, and functions as an output unit. The display device 918 is configured by, for example, a liquid crystal display, an organic EL display, electronic paper, or a projector, and functions as an output unit. The input device 916 and the display device 918 may be configured integrally, for example, as a touch panel display. The storage device 920 is configured by, for example, an HDD, an SSD, and functions as a storage unit. The storage device 920 stores various data necessary for executing the operating system and the program 930.

The communication I/F unit 922 is wired or wirelessly connected to a network 940 such as the Internet or an intranet (which may be the same as the network 4 in FIG. 1) and functions as a communication unit that sends/receives data to/from another computer in accordance with a predetermined communication standard. The external device I/F unit 924 is wired or wirelessly connected to an external device 950 such as a camera, a printer, a scanner, or a reader/writer. Further, the external device I/F unit 924 functions as a communication unit that transmits/receives data to/from the external device 950 according to a predetermined communication standard. The I/O device I/F unit 926 is connected to an I/O device 960 such as a sensor or an actuator, and functions as a communication unit that transmits/receives various signals and data to/from the I/O device 960, such as detection signals by sensors and control signals to actuators. The media I/O unit 928 is configured by a drive device such as a DVD drive or a CD drive, and reads/writes data to/from a medium (non-transient storage medium) 970 such as a DVD or a CD.

In the computer 900 having the above configuration, the processor 912 calls and executes the program 930 stored in the storage device 920 to the memory 914 and controls various parts of the computer 900 via the bus 910. The program 930 may be stored in the memory 914 instead of in the storage device 920. The program 930 may be recorded on the medium 970 in an installable file format or an executable file format and may be provided to the computer 900 via the media I/O unit 928. The program 930 may be provided to the computer 900 by being downloaded via the network 940 via the communication I/F unit 922. The computer 900 may also be a hardware realization of various functions realized by the processor 912 executing the program 930, such as, for example, an FPGA or ASIC.

The computer 900 may be configured by, for example, a stationary computer or a portable computer, which may be any form of electronic device. The computer 900 may be a client computer, a server computer, or a cloud computer, or may be an embedded computer referred to as a control distribution board or a controller (including a microcontroller, a programmable logic controller, and a sequencer).

### (Operation of Drawing Processing Device 2A)

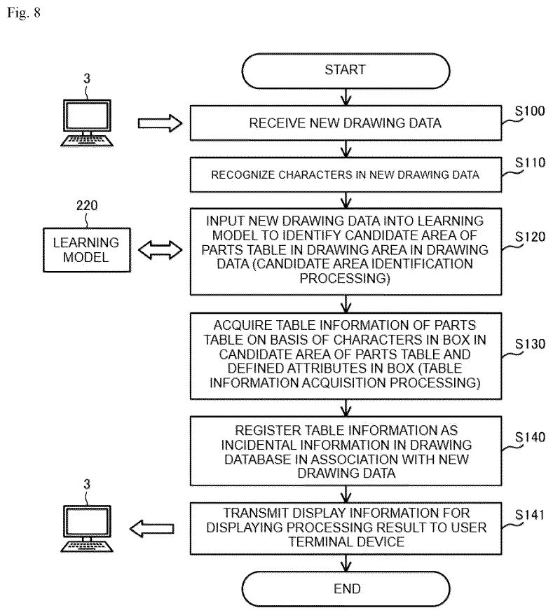

FIG. 8 is a flowchart showing an example of the operation (drawing processing method) of the drawing processing device 2A according to the first embodiment. In the following description, the series of steps in the drawing processing method performed by the drawing processing device 2A shown in FIG. 8 are executed when the drawing processing device 2A receives the new drawing data D10 from the user terminal device 3 operated by the user. Further, in the following description, as shown in FIG. 5, the learning model generation unit 201A causes the learned model storage unit 22 to perform a learning data acquisition step, a machine learning step, and a learned model storage step, to thereby store the learned learning model 220.

First, in step S100 (drawing acceptance step), the drawing reception unit 202 receives the drawing data D10 from the user terminal device 3, thereby receiving the new drawing data D10. In this case, the drawing reception unit 202 may receive a plurality of pieces of the drawing data D10.

Next, in step S110 (character recognition step), the character recognition unit 203 recognizes the characters in the drawing data D10 received in step S100.

Next, in step S120 (drawing processing step), the drawing processing unit 204A performs candidate area identification processing to identify the candidate area 14 in the parts table 13 in the drawing area 10 of the new drawing data D10 by inputting the new drawing data D10 into the learning model 220.

Then, in step S130, the drawing processing unit 204A performs table information acquisition processing to acquire the table information of the parts table 13 on the basis of the characters in the box in the candidate area 14 of the parts table 13, specifically, the characters recognized in step S110, and the attributes specified for the box.

Next, in step S140 (database management step), the database management unit 205 registers the table information acquired as the result of the processing in steps S120 and S130 as the incidental information D12 in the drawing database 210 in association with the drawing data D10 received in step S100.

Then, in step S141, the database management unit 205 sends the display information to the user terminal device 3 for displaying the results of the processing in steps S120 and S130. As a result, the incidental information D12 registered for the new drawing data D10 is displayed on the display screen of the user terminal device 3.

As described above, with the drawing processing device 2A and the drawing processing method according to this embodiment, the drawing processing unit 204A identifies the candidate area 14 where the table to be detected is located and acquires the table information from the identified candidate area 14. Thus, even in a case where the position of the table in the drawing area 10 of the drawing data D10, the number of rows and columns of the table, the attributes of each box that make up the table, or the like differ depending on the drawing data D10, it is possible to acquire the information described in the table in the drawing data D10 as the table information.

In this case, the drawing processing unit 204A can identify the candidate area 14 and acquire the table information without performing complex image processing by using the learned learning model 220 to correlate the drawing data D10 with the candidate area 14.

### Second Embodiment

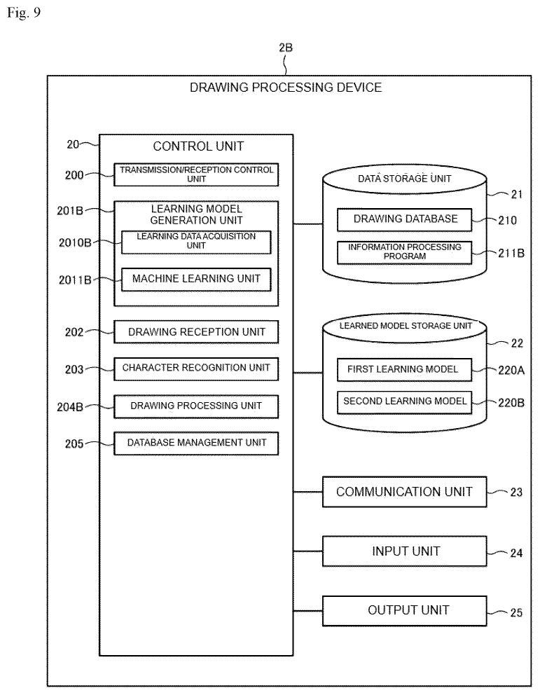

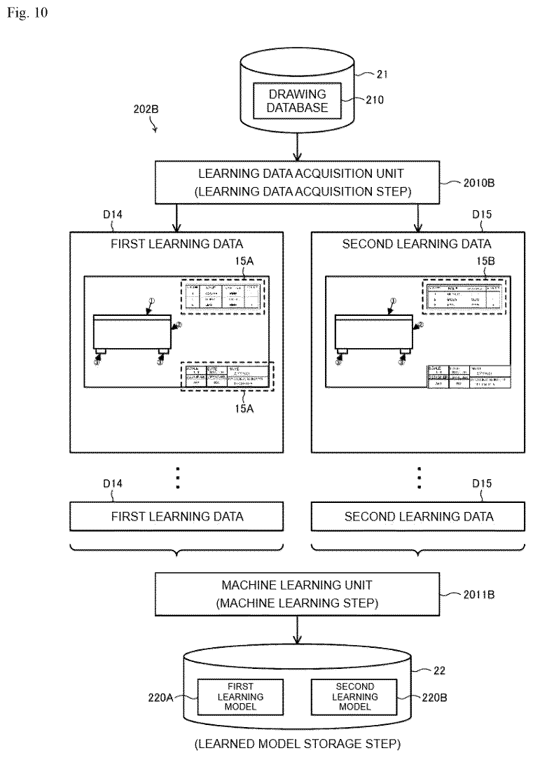

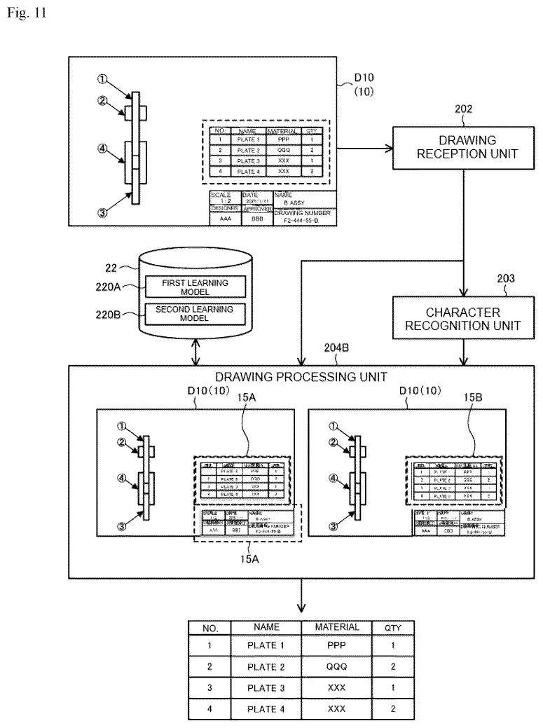

FIG. 9 is a block diagram showing an example of a drawing processing device 2B according to a second embodiment. FIG. 10 is a functional illustration of an example of a learning model generation unit 201B according to the second embodiment. FIG. 11 is a functional illustration of an example of a drawing reception unit 202, a character recognition unit 203, and a drawing processing unit 204B according to the second embodiment.

In the second embodiment, the drawing processing device 2B differs from the drawing processing device 2 of the first embodiment in that two learning models 220A and 220B are used to acquire the table information. The following description will focus on the differences between the drawing processing device 2B according to the second embodiment and the first embodiment.

A first learning model 220A and a second learning model 220B for learning are stored in the learned model storage unit 22.

The control unit 20 executes an information processing program 211B recorded in the data storage unit 21 to function as the transmission/reception control unit 200, the learning model generation unit 201B, the drawing reception unit 202, the character recognition unit 203, the drawing processing unit 204B, and the database management unit 205.

### (Learning Model Generation Unit 201B)

As shown in FIGS. 9 and 10, the learning model generation unit 201B includes a learning data acquisition unit 2010B and a machine learning unit 2011B.

The learning data acquisition unit 2010B acquires first learning data D14 and second learning data D15 with reference to the drawing database 210.

The input data of the first learning data D14 is the drawing data D10. The input data that makes up the first learning data D14 may also include text data indicating the characters written in the drawing area 10 and position data indicating the position where the characters are written, as the recognition result of the character recognition unit 203.

The output data of the first learning data D14 is a table area 15A that surrounds the table in the drawing area 10 of the drawing data D10. In a case where the drawing data D10 contains a plurality of tables, a plurality of table areas 15A are specified to surround each table. In other words, in the drawing data D10 shown in FIG. 2, the table area 15A corresponds to the area surrounding the title field 12 and the area surrounding the parts table 13.

The input data of the second learning data D15 is the drawing data D10. The input data of the second learning data D15 may include text data indicating the characters written in the drawing area 10 and position data indicating the position where the characters are written, as the recognition result of the character recognition unit 203.

The output data of the second training data D15 is a feature area 15B that surrounds the box of the table to be detected in the drawing area 10 of the drawing data D10. In the drawing data D10 shown in FIG. 2, the title field 12 and the parts table 13 correspond to the table to be detected. This embodiment will focus on a description where the table to be detected is the parts table 13. Therefore, the feature area 15B corresponds to the area surrounding the parts table 13 in the drawing data D10 shown in FIG. 2.

The learning data acquisition unit 2010B performs annotation on the drawing data D10 registered in the drawing database 210 to acquire the first learning data D14 and the second learning data D15.

For example, the learning data acquisition unit 2010B displays the drawing data D10 on the display screen of the drawing processing device 2B or the user terminal device 3 and accepts an input operation of the table areas 15A as annotation in the drawing area 10 on the display screen such that the title field 12 and the parts table 13 are surrounded to acquire the first learning data D14.

The learning data acquisition unit 2010B displays the drawing data D10 on the display screen of the drawing processing device 2B or the user terminal device 3 and accepts an input operation of the feature area 15B as annotation in the drawing area 10 on the display screen such that the box of the table to be detected is surrounded to acquire the second learning data D15.

The machine learning unit 2011B performs machine learning of the first learning model 220A using a plurality of sets of the first learning data D14 acquired by the learning data acquisition unit 2010B. In addition, the machine learning unit 2011B performs machine learning of the second learning model 220B using a plurality of sets of the second learning data D15 acquired by the learning data acquisition unit 2010B.

### (Drawing Processing Unit 204B)

As shown in FIG. 11, the drawing processing unit 204B performs table area identification processing to identify the table area 15A, which is the area of the drawing area 10 of the new drawing data D10 where the table is located, feature area identification processing to identify the feature area 15B, which is the area of the drawing area 10 of the new drawing data D10 where the box of the table to be detected is located, candidate area identification processing to identify the candidate area 14 on the basis of the table area 15A identified by the table area identification processing and the feature area 15B identified by the feature area identification processing, and table information acquisition processing of acquiring table information about the table to be detected from the candidate area 14 identified by the candidate area identification processing.

As the table area identification processing, the drawing processing unit 204B identifies the table area 15A in the drawing area 10 of the new drawing data D10 by inputting the new drawing data D10 into the first learning model 220A. In other words, in the table area identification processing, the table area 15A, which is likely to contain a table, is identified from the drawing area 10. Thus, in the table area identification processing, the area that is likely to contain a table is identified as the table area 15A, without distinguishing whether the table is the title field 12 or the parts table 13.

As the feature area identification processing, the drawing processing unit 204B identifies the feature area 15B in the drawing area 10 of the new drawing data D10 by inputting the new drawing data D10 into the second learning model 220B. In other words, in the feature area identification processing, the feature area 15B, which is likely to contain the boxes of the table to be detected (in this embodiment, the parts table 13), is identified in the drawing area 10. Thus, in the feature area identification processing, the feature area 15B, which is likely to contain features to be detected (e.g., arrangement and number of boxes) in the table to be detected, is identified without distinguishing whether the table is present.

As the candidate area identification processing, the drawing processing unit 204B identifies the area where the table area 15A identified by the table area identification processing and the feature area 15B identified by the feature area identification processing overlap as the candidate area 14. In other words, an area where the table area 15A identified as an area that is likely to contain something that looks like a table in the table area identification processing and the feature area 15B identified as an area that is likely to contain something that looks like the feature to be detected in the table to be detected in the feature area identification processing overlap is an area that contains something that looks like a table and something that looks like the feature to be detected in the table to be detected. Thus, in the candidate area identification processing, such an area is identified as the candidate area 14 containing the table to be detected (in this embodiment, the parts table 13). The drawing processing unit 204B may identify an area where the table area 15A and the feature area 15B overlap as the candidate area 14, or may identify the table area 15 as the candidate area 14 when at least a part of the table area 15 overlaps the feature area 15B.

As the table information acquisition processing, the drawing processing unit 204B acquires the table information on the basis of the characters recognized by the character recognition unit 203, specifically, the characters in the boxes in the candidate area 14, and the attributes specified for the boxes.

### (Operation of Drawing Processing Device 2B)

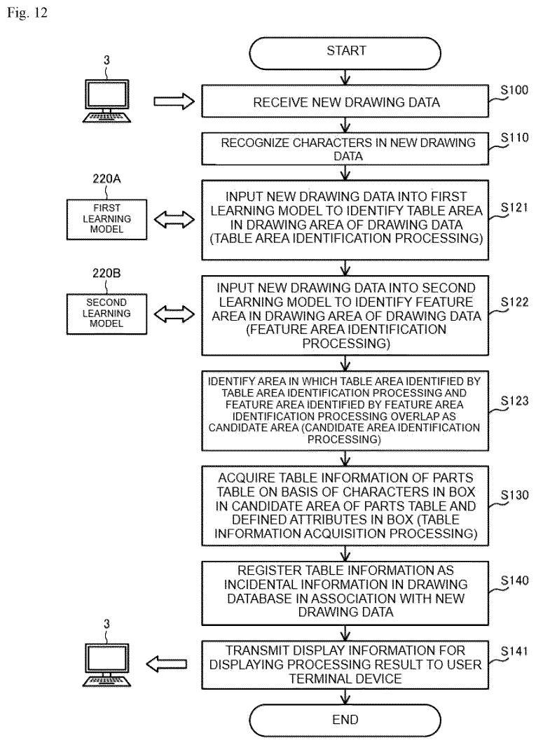

FIG. 12 is a flowchart showing an example of the operation (drawing processing method) of the drawing processing device 2B according to the second embodiment. Steps denoted by the same step numbers as those in the flowchart shown in FIG. 8 are the same as in the first embodiment, and the description will focus on the differences between the second embodiment and the first embodiment.

First, in step S100 (drawing reception step), the drawing reception unit 202 receives the new drawing data D10 and, in step S110 (character recognition step), the character recognition unit 203 recognizes the characters in the drawing data D10 received in step S100.

Next, in step S121 (drawing processing step), the drawing processing unit 204B performs the table area identification processing to identify the table area 15A in the drawing area 10 of the new drawing data D10 by inputting the new drawing data D10 into the first learning model 220A.

Next, in step S122, the drawing processing unit 204B performs the feature area identification processing to identify the feature area 15B in the drawing area 10 of the new drawing data D10 by inputting the new drawing data D10 into the second learning model 220B.

Next, in step S123, the drawing processing unit 204B performs the candidate area identification processing to identify the area where the table area 15A identified in step S121 and the feature area 15B identified in step S122 overlap as the candidate area 14.

Then, in step S130, the drawing processing unit 204B performs the table information acquisition processing to acquire the table information of the parts table 13 on the basis of characters in the boxes disposed in the candidate area 14 of the parts table 13 among the characters recognized in step S110 and the defined attributes in the boxes.

Next, in step S140 (database management step), the database management unit 205 registers the table information acquired as the result of processing in steps S120 and S130 as the incidental information D12 in the drawing database 210. Then, in step S141, the database management unit 205 transmits display information for displaying the results of the processing in steps S120 and S130 to the user terminal device 3.

As described above, with the drawing processing device 2B and the drawing processing method according to this embodiment, the drawing processing unit 204B identifies the candidate area 14 where the table to be detected is located and acquires the table information from the identified candidate area 14. Thus, even in a case where the position of the table in the drawing area 10 of the drawing data D10, the number of rows and columns of the table, the attributes of each box that makes up the table, and the like differ depending on the drawing data D10, it is possible to acquire the information described in the table in the drawing data D10 as the table information.

At that time, the drawing processing unit 204B uses the first learning model 220A that has learned the correlation between the drawing data D10 and the table area 15A and the second learning model 220B that has learned the correlation between the drawing data D10 and the feature area 15B to identify the candidate area 14 and acquire the table information without performing complicated image processing.

### Other Embodiments

The present invention is not limited to the embodiments described above and can be implemented with various modifications within the scope that does not depart from the main purpose of the invention. All such modifications are included in the technical concept of the present invention.

In the above-described embodiments, the drawing processing device 2A, 2B consists of a single device, but the drawing processing device 2A, 2B may also consist of multiple devices. For example, the drawing processing device 2A, 2B may include units 202 to 205 that are distributed across multiple devices such that the drawing management system 1 includes, in addition to the drawing processing device 2A, 2B, a character recognition device that includes the character recognition unit 203 and performs the character recognition step, and a machine learning device that includes the learning model generation units 201A and 201B and performs the machining learning step. With this configuration, each unit (each step) provided by each of the above devices may be realized by a program executable by the computer 900.

In the above-described embodiments, a case is described where the drawing processing device 2A, 2B receives the new drawing data D10 from the user terminal device 3 to acquire the table information related to the table in the drawing data D10. However, the user terminal device 3 may function as the drawing processing device 2A, 2B.

In the above-described embodiments, a case is described where the drawing processing device 2A, 2B includes the character recognition unit 203 separate to the drawing processing unit 204A, 204B. However, the drawing processing unit 204A, 204B may have a function of recognizing characters in the drawing data D10, similar to the character recognition unit 203. For example, the learning model 220, 220A, 220B may have a function of recognizing characters in the drawing data D10. In that case, the drawing processing unit 204A, 204B may input the new drawing data D10 into the learning model 220, 220A, 220B to recognize the characters in the drawing data D10.

### REFERENCE SIGNS LIST

1 Drawing management system
2A, 2B Drawing processing device
3 User terminal device
10 Drawing area
11 Shape area
12 Title field
13 Parts table
14 Candidate area
15A Table area
15B Feature area
20 Control unit
21 Data storage unit
22 Learned model storage unit
23 Communication unit
24 Input unit
25 Output unit
200 Transmission/reception control unit
201A, 201B Learning model generation unit
202 Drawing reception unit
203 Character recognition unit
204A, 204B Drawing processing unit
205 Database management unit
210 Drawing database
211A, 211B Information processing program
220 Learning model
220A First learning model
220B Second learning model

1. A drawing processing device comprising:
a drawing reception unit configured to receive drawing data including characters in boxes divided by rule lines and including one or more tables in which attributes of the characters are defined in the boxes; and
a drawing processing unit configured to acquire table information related to a table to be detected in a drawing area of the drawing data received by the drawing reception unit from a candidate area containing the table to be detected, the table including a feature to be detected,
the drawing processing unit being configure to perform:
table area identification processing of identifying a table area containing the table in the drawing area;
feature area identification processing of identifying a feature area containing the boxes of the table to be detected in the drawing area;
candidate area identification processing of identifying the candidate area on the basis of the table area identified by the table area identification processing and the feature area identified by the feature area identification processing; and
table information acquisition processing of acquiring the table information from the candidate area identified by the candidate area identification processing.

2. The drawing processing device according to claim 1, wherein
the drawing processing unit performs the table area identification processing of identifying the table area in the drawing area of the drawing data by inputting the drawing data into a first learning model,
the drawing processing unit performs the feature area identification processing of identifying the feature area in the drawing area of the drawing data by inputting the drawing data into a second learning model,
the first learning model is a model subjected to machine learning to learn a correlation between the drawing data and a table area surrounding the table in the drawing data, and
the second learning model is a model subjected to machine learning to learn a correlation between the drawing data and a feature area surrounding the boxes of the table to be detected in the drawing data.

3. The drawing processing device according to claim 1, further comprising
a character recognition unit configured to recognize the characters in the drawing area, wherein
the drawing processing unit performs the table information acquisition processing of acquiring the table information on the basis of characters in the boxes disposed in the candidate area among the characters recognized by the character recognition unit and the defined attributes in the boxes.

4. A drawing processing method to be executed by a computer, the method comprising:
a drawing reception step of receiving drawing data including characters in boxes divided by rule lines and including one or more tables in which attributes of the characters are defined in the boxes; and
a drawing processing step of acquiring table information related to a table to be detected in a drawing area of the drawing data received by the drawing reception unit from a candidate area containing the table to be detected, the table including a feature to be detected,
the drawing processing step comprising:
table area identification processing of identifying a table area contained in the table in the drawing area;
feature area identification processing of identifying a feature area contained in the boxes of the table to be detected in the drawing area;
candidate area identification processing of identifying the candidate area on the basis of the table area identified by the table area identification processing and the feature area identified by the feature area identification processing; and
table information acquisition processing of acquiring the table information from the candidate area identified by the candidate area identification processing.
